(19) United States
(12) Patent Application Publication
(10) Pub. No.: US 2015/0235552 A1
(43) Pub. Date: Aug. 20, 2015

(54) METHOD AND APPARATUS FOR CONTROLLING ELECTRICAL DEVICES THROUGH AC POWER LINE

(71) Applicants: Charles Jun Cai, Mather, CA (US); Jeff Kotowski, Nevada, CA (US)

(72) Inventors: Charles Jun Cai, Mather, CA (US); Jeff Kotowski, Nevada, CA (US)

(21) Appl. No.: 14/184,724

(22) Filed: Feb. 20, 2014

(51) Int. Cl. G08C 19/00; H04B 3/54

(52) U.S. Cl. CPC G08C 19/00; H04B 3/54

(57) ABSTRACT

Embodiments disclosed herein describe an AC power line instruction system which can control the operation of electrical device through the AC power line. The AC power line instruction system comprises a modulator to modulate the timing of the leading edges of the voltage of the AC power line to transmit a command signal, and a receiver to measure the timing of the leading edges of the voltage of the AC power line, to decode the command signal based on the relationship between the timing of the leading edges, and the operation of the electrical device can be controlled by the command signal decoded by the receiver.

### CROSS REFERENCE TO RELATED APPLICATIONS

Not applicable.

### FIELD OF INVENTION

This invention relates to controlling the operation of electrical device through the AC (Alternating Current) power line.

### BACKGROUND OF INVENTION

Many electrical devices such as light, fan are powered by AC voltage though installed AC power lines in house or office. An electrical switch mounted on the wall is usually used to turn on and off these electrical devices. Since there is no additional signal line available together with the AC power line, it is not easy to control the electrical device in a more advanced way such as to change the brightness of a light or the speed of a fan or to control two electrical devices independently. For example many people have ceiling fan together with light installed in house or office. The electrical switch on the wall usually can only turn on or off the ceiling fan and the light together. To be able to independently control the speed of the ceiling fan and the brightness of the light, two pull chains from the ceiling fan are usually used. One pull chain is used to control the speed of the ceiling fan, and the other pull chain is used to control the brightness of light. This approach is very common on today's market, but is very inconvenient for people to use. To be able to independently control the speed of the fan and the brightness of the light, two separate active wires (also called “hot wire” or “live wire”) are needed from the electrical switch mounted on the wall to the ceiling fan. And if these two active wires have not been pre-installed in house or office, it will be very expensive to install them.

Another example is that to be able to control the brightness of a light, people usually uses a TRIAC (Triode for Alternating Current) dimmer. The TRIAC dimmer chops part of the AC voltage waveform to change the brightness of the light. The TRIAC dimmer is integrated into the electrical switch mounted on the wall. But the TRIAC dimmer cannot do more advanced control such as to change the color of a light. When the TRIAC dimmer chops the AC voltage waveform, the Power Factor (PF) of the AC power line becomes worse. This is undesirable since it, on average, requires the power utility company to provide higher power to the house or office, and more power will be lost during the power distribution.

Some companies try to provide solutions to solve the problems. For example, some use a wireless remote controller to control the speed of the fan and the brightness of the light in the ceiling fan. This approach has its drawbacks. First the wireless remote control needs to change battery once a while which costs money and effort. Second the wireless communication is not robust and is prone to interference from other wireless signals such as from garage openers of your neighbors. Some suggest to use a smart phone to control the brightness and color of a light, using Zigbee, Bluetooth or Wifi technologies. But this approach is not feasible for many people who do not use a smart phone such as children and elderly people. Also the up to 10 seconds delay (counting the time of turning on the smart phone, unlocking it, launching the control app, finding the right light to control, etc.) by using a smart phone to control a light's brightness or color is not appealing to many people. And the Zigbee, Bluethooth or Wifi receiver working with the smart phone is always burning power even when the light itself is off. To completely eliminate the power consumption when the light is not used, people need to approach and push the electrical switch mounted on the wall to turn off the receiver, and need to push the electrical switch on the wall again to turn the receiver back on next time to be able to use the smart phone to control the light. This requirement can make the smart phone solution less appealing. Some companies try to use the AC power line itself to control the electrical device coupled to it. They transmit a control signal over the AC power line when the AC voltage is at zero crossing point or its peak value. But this solution usually requires a neutral line to provide a reference voltage. Many houses or offices built in early years don't have the neutral line routed to the electrical switch on the wall, and there are only one wire (called “active wire”) coming to the electrical switch and another wire (called “load wire”) going out. This is commonly called “two-wire” connection. Houses and offices with two-wire connection system installed in early years cannot use this solution which requires the neutral line.

Hence it is highly desirable to have a solution to control the electrical device, which is convenient to use, robust, low cost, versatile (can control the color of a light, for example), and is compatible with existing two-wire connection in houses or offices.

This invention disclosed methods and structures of an AC power line instruction system, to control electrical devices through the AC power line. It can provide a solution for the problems mentioned above, and provide a better way to give the electrical devices a more advanced control. It can control the brightness of the light and the speed of the fan independently through a two-wire connection system. It can possibly control the color or the brightness of a light while still maintaining a very good power factor for the AC power line.

### SUMMARY

The methods and structures disclosed by this invention describe an AC power line instruction system, which comprises a modulator to modulate the timing of the leading edges of the voltage of the AC power line to transmit a command signal, and a receiver to measure the timing of the leading edges of the voltage of the AC power line, to decode the command signal based on the relationship between the timing of the leading edges, and the operation of the electrical device can be controlled by the command signal decoded by the receiver.

One embodiment disclosed in this invention shows an AC power line instruction system to control a ceiling fan together with a light. It uses exiting two-wire connection at wall and can control the speed of the ceiling fan and the brightness of the light independently.

Another embodiment disclosed in this invention shows an AC power line instruction system to control the color and the brightness of a light. It uses existing two-wire connection at wall, and can possibly maintain high power factor for the AC power line.

The typical application of this invention can be an AC power line instruction system to control a ceiling fan with a light. The fan and the light can be controlled independently through existing two-wire connection on the wall. Another typical application of this invention can be an AC power line instruction system to control a light. The brightness and the color of the light can be controlled through existing two-wire connection on the wall while still maintaining high power factor for the AC power line. The solution from this invention does not require neutral line at the switch box on wall so it can retrofit most of the existing electrical wiring systems at homes and offices.

### BRIEF DESCRIPTION OF THE DRAWINGS

Embodiments of the invention relating to both structures and methods of operation may best be understood by referring to the following descriptions and accompanying drawings:

FIG. 1 shows a prior art about how electrical device is controlled;

FIG. 2 shows the waveforms for the embodiment in FIG. 1;

FIG. 3 shows an embodiment of a modulator of this invention which is compatible with existing two-wire connection system;

FIG. 4 shows an embodiment of a receiver of this invention to control a ceiling fan and a light independently;

FIG. 5 shows another embodiment of a receiver of this invention to control the color and brightness of a light independently;

FIG. 6 shows an embodiment of an AC power line instruction system of this invention to control a ceiling fan and a light independently.

### DETAILED DESCRIPTION

Many electrical devices such as lights, fans at homes or offices use AC power which is conveniently available. The AC (Alternating Current) voltage is 120 volts, 60 hertz in USA and many countries, and can be 220 volts, 50 hertz in other countries. In many homes or offices in USA, the AC power is distributed through an electrical wiring system, which usually has an “active wire” (also called “hot wire” or “live wire”) going from an electrical circuit breaker panel to an electrical switch on the wall, and a “neutral wire” going from the electrical circuit breaker panel to an electrical load such as a light. (Also there usually is a “ground wire” going from the electrical circuit breaker panel to the electrical load to provide a safety protection, which is not discussed here.) From the electrical switch on the wall, a “load wire” is routed to the electrical load to provide power. So by switching on or off the electrical switch on the wall, the electrical load such as a light can be turned on or off. The electrical switch on the wall does not have access to the neutral wire, and it only connects to the active wire and the load wire. This is often called “two-wire” connection. To be able to further control the brightness of the light, a TRIAC (Triode for Alternating Current) dimmer is usually used instead of the electrical switch. To retrofit the existing two-wire connection, a “two-wire dimmer” is commonly used, which connects to the active wire and the load wire.

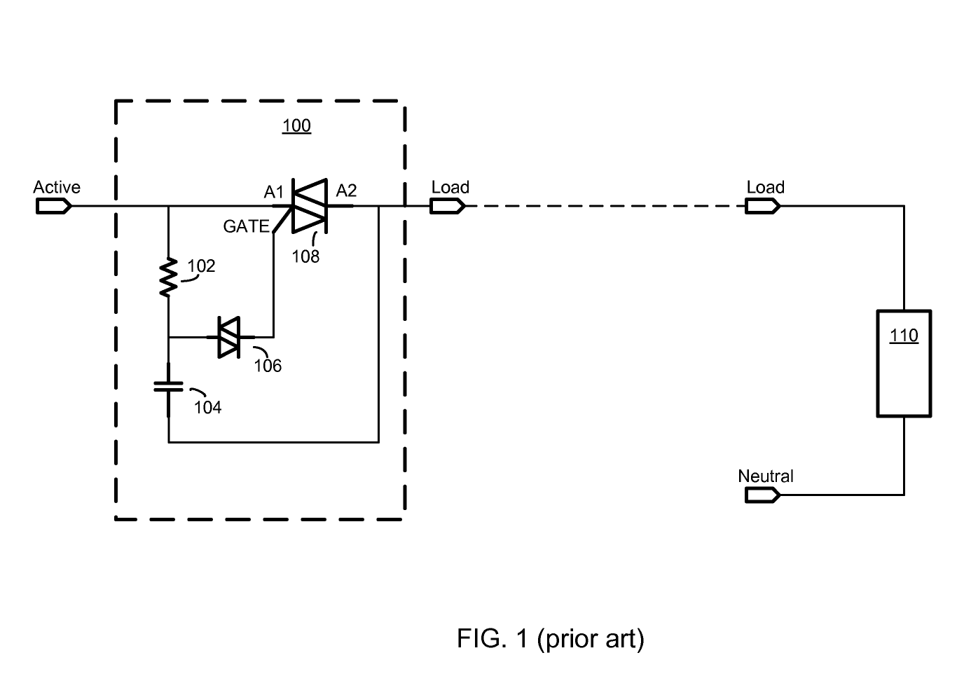

FIG. 1 shows an embodiment of a prior art of using a two-wire dimmer to control an electrical load. In FIG. 1, the embodiment includes a two-wire dimmer 100 coupled between an active wire and a load wire, which is usually mounted on the wall. The embodiment also includes an electrical device 110 coupled between the load wire and a neutral wire, which can be a light or fan mounted on the ceiling. The load wire is routed from the two-wire dimmer 100 to the electrical device 110. The two-wire dimmer 100 includes a resistor 102 and a capacitor 104 connected in series and coupled between the active wire and the load wire, and a TRIAC (Triode for Alternating Current) 108 with its A1 and A2 terminals coupled to the active wire and the load wire. The two-wire dimmer 100 also includes a DIAC (Diode for Alternating Current) 106 which is coupled between the GATE terminal of the TRIAC 108 and the interconnection point of the resistor 102 and the capacitor 104. The operation of the two-wire dimmer 100 is well known: it chops off part of the AC voltage between the active wire and the neutral wire to change the power level of the electrical device 110. People can adjust the resistance of the resistor 102 to change the turn-on angle of the TRIAC 108, thus to change the portion of the AC voltage chopped off.

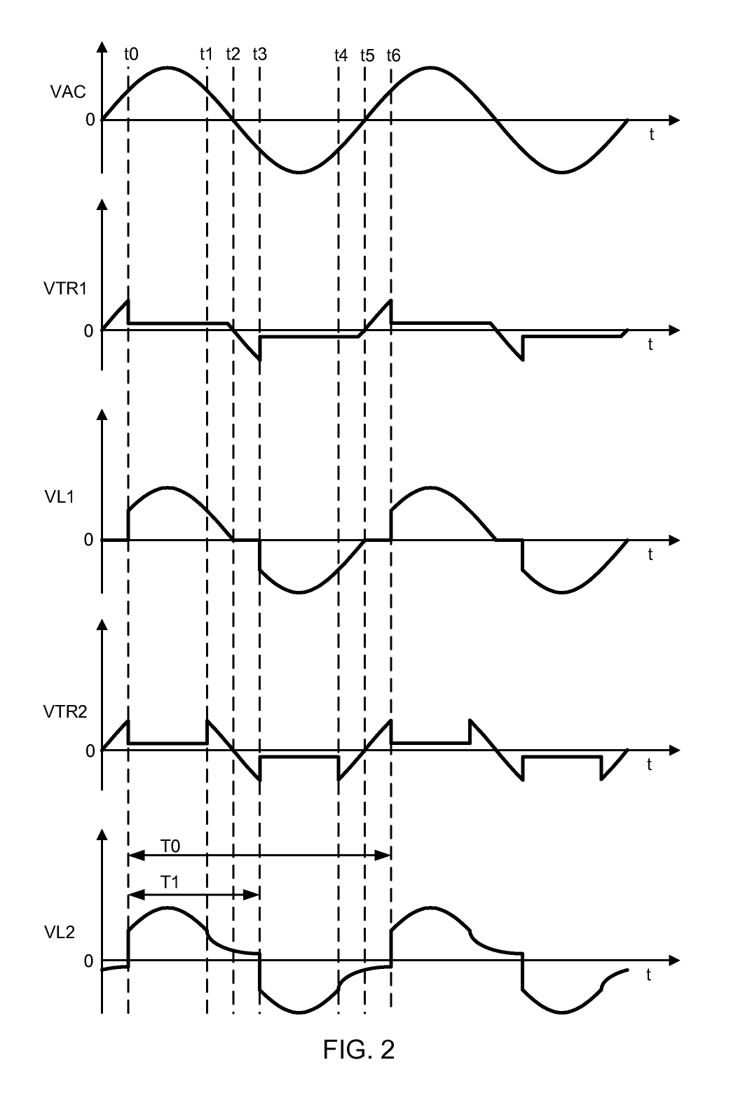

FIG. 2 shows the waveforms for the embodiment in FIG. 1. In FIG. 2, the waveform VAC is the incoming AC voltage between the active wire and the neutral wire, which is a sinusoidal waveform with 60 or 50 hertz frequency. The waveform VTR1 is the voltage across the TRIAC 108, and the waveform VL1 is the waveform across the electrical device 110 when the electrical device 110 is a pure resistive load such as incandescent lamp. Since the impedance of the electrical device 110 is resistive, so the current flowing through the TRIAC 108 and the electrical device 110 should be in phase with the VAC. At time t0, the TRIAC 108 is turned on, so the VTR1 drops to the on-state voltage of the TRIAC 108, which is usually 1˜2 volts, and the VL1 increases to be almost the same value as VAC. At time t2, VAC and the current flowing through the TRIAC 108 drop to zero which is less than the holding current of the TRIAC 108, so the TRIAC 108 is turned off. When the TRIAC 108 is turned off, the VL1 drops to zero and the VTR1 will follow the value of the VAC. After some delay which is controlled by the values of the resistor 102 and the capacitor 104, at time t3 the TRIAC 108 is turned back on, so the VTR1 drops to the negative on-state voltage which is usually −1˜−2 volts and the VL1 will follow the value of the VAC. The TRIAC 108 will again turn off at time t5 and turn back on at time t6. When the TRIAC 108 turns on at time t3 or time t6, the VL1 will have a sharp “leading edge”. Then the VL1 will follow the VAC until it reaches zero crossing point. The time delay between the zero crossing point and the leading edge (for example, between time t2 and t3, and between time t5 and t6) is controlled by the values of the resistor 102 and the capacitor 104. For example, if the resistance of the resistor 102 is changed, the position of the leading edge will also change. But in many cases the electrical device 110 may not be an incandescent lamp and its impedance is not pure resistive. For example the electrical device 110 may be a LED light with non-linear and capacitive impedance, then the current flowing through the TRIAC 108 and the electrical device 110 will have a phase lead with respect to the VAC. In this scenario, the VTR2 shows the voltage across the TRIAC 108, and the VL2 shows the voltage across the electrical device 110. At time t1, although the VAC has not dropped to zero, but the current flowing through the TRIAC 108 has dropped to close to zero which is less than the holding current of the TRIAC 108 so the TRIAC 108 will turn off. The VTR2 will follow the VAC since now the TRIAC 108 is off and has very high impedance. The VL2 will decay and the decaying speed depends on the capacitance and impedance between the load wire and the neutral wire when the TRIAC 108 is off. In many cases the decaying speed can be very slow so the VL2 will not have a zero crossing point before its leading edge. So it can be very difficult and inaccurate to know the position of the leading edge of the VL2 with respect to its zero crossing point. But the time delay T0 between two positive leading edges of the VL2 at time t0 and time t6 should be constant and independent of any impedance variation of the electrical device 110. And the time delay T1 between a positive leading edge of the VL2 at time t0 and a negative leading edge of the VL2 at time t3 should be half of the T0 and also independent of any impedance variation of the electrical device 110.

In the methods and structures disclosed in this invention, there is a modulator to modulate the timing of the leading edges of the AC voltage to transmit a command signal, and a receiver to measure the timing of the leading edges of the AC voltage, to decode the command signal based on the relationship between the timing of the leading edges, and the operation of the electrical device can be controlled by the command signal decoded by the receiver.

In following paragraphs embodiments of this invention will be shown for example to explain the concept of the invention in detail. However it should be understood that it is not intended to limit the invention to the particular structures and methods disclosed, but on the contrary, the intention is to cover all the structure and method modifications, equivalents and alternatives falling within the scope of the invention defined by the appended claims.

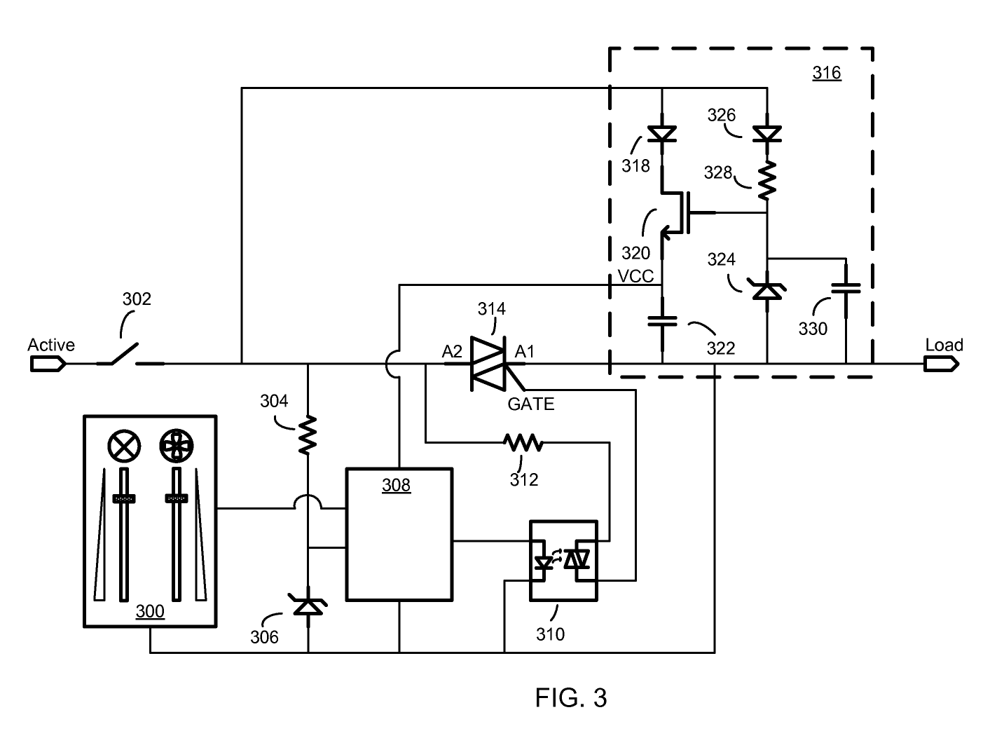

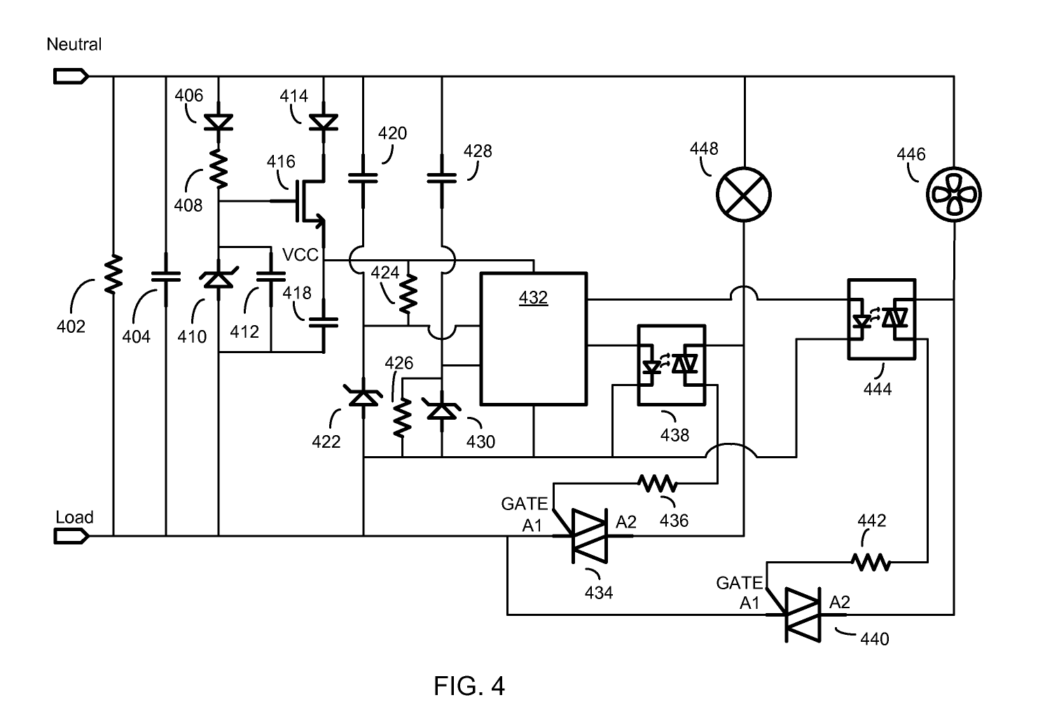

FIG. 3 shows an embodiment of a modulator of the invention which couples between an active wire and a load wire using two-wire connection. In FIG. 3, the embodiment includes a physical switch 302 connected to the active wire and the A2 terminal of a modulator switch element 314. (The AC voltage is between the active wire and a neutral wire which is shown in FIG. 4.) The modulator switch element 314 in this embodiment can be a TRIAC. In FIG. 3, the A1 terminal of the TRIAC 314 is connected to a load wire. There is a resistor 304 connected to a zener diode 306 and then coupled between the load wire and the A2 terminal of the TRIAC 314. Also there is a modulator encoding block 300 coupled to the load wire and a modulator MCU (Micro-programmed Control Unit) 308. The modulator MCU 308 is also coupled to the interconnection of the resistor 304 and the zener diode 306, an optoisolator TRIAC driver 310 and a node VCC. The optoisolator TRIAC driver 310 is also coupled to the load wire, the A2 terminal of the TRIAC 314 through a resistor 312, and the GATE of the TRIAC 314. The embodiment also includes a modulator power supply block 316 coupled between the load wire, the modulator MCU 308 and the A2 terminal of the TRIAC 314. Inside the modulator power supply block 316, there are a diode 318, a NMOSFET 320 and a capacitor 322 connected in series. There are also a diode 326, a resistor 328 and a zener diode 324 connected in series. There is also a capacitor 330 coupled in parallel with the zener diode 324. The modulator power supply block 316 is to provide power for the modulator MCU 308 through the node VCC. Every time when the voltage of the active wire is higher than the voltage on the load wire by a predetermined value (and when the physical switch 302 is closed), the NMOSFET 320 will be turned on to charge the capacitor 322. When the voltage of the active wire is less than the voltage of the load wire, or when the TRIAC 314 is turned on, the diode 318 and the NMOSFET 320 are off, and the energy stored on the capacitor 322 will be used to power the modulator MCU 308. If the modulator MCU 308 uses for example 5V voltage, then the zener diode 324 and the NMOSFET 320 will be chosen so that the voltage at node VCC will be close to 5V. The optoisolator TRIAC driver 310, the resistor 312 and the TRIAC 314 compose a modulator switching block to turn on and off the AC voltage. The resistor 304 and the zener diode 306 compose a zero crossing detection block, to detect when the AC voltage is zero. After a predetermined time delay after the zero crossing point, the modulator MCU 308 will turn on the TRIAC 314 through the optoisolator TRIAC driver 310. So the modulator MCU 308 can control the time delay T0 and the time delay T1 shown in FIG. 2. By changing the values of the time delay T0 and the time delay T1, a command signal can be sent over the load wire and detected by a receiver which will be shown in next paragraphs. In FIG. 3, when the TRIAC 314 is turned on, the on-state voltage across the TRIAC 314 will be very small (usually 1˜2V) and cannot turn on the diode 318 and the NMOSFET 320 to charge the capacitor 322. It is desirable that there is a time delay after the zero crossing point of the voltage across the TRIAC 314 before turning on the TRIAC 314, so before the TRIAC 314 is turned on the voltage across the TRIAC 314 can be high enough to charge the capacitor 322. If this time delay is too short, then the capacitor 322 may not be charged enough. If this time delay is too long, then the TRIAC 314 may block the AC voltage too much and compromise its integrity so its power factor (PF) can be poor. The actual time delay will depend on the application, but it is recommended that the time delay will be a perdetermined value that when the TRIAC 314 is turned on the voltage across the TRIAC 314 is between 10V to 50V. Normally the time delay T1 is half of the time delay T0 as shown in FIG. 2. The modulator MCU 308 can modulate the AC voltage and change the relationship of the time delay T1 and T0 to transmit a command signal. For example, if the time delay T1 is half of the time delay T0, it means a logic signal “0”. If the time delay T1 is more than half of the time delay T0, it means a logic signal “1”. Thus by changing the relationship of the T0 and T1, a command signal with a series of digital bits can be transmitted. This data transmission can be done “permanently” which means the transmission is done again and again without stopping. Or this data transmission can be done “temporarily” which means to transmit the command signal only one or two or several times and stop transmission after that. To transmit a logic “1”, the time delay T1 should be more than half of the time delay T0 by a predetermined value. This predetermined value should be big enough so it is easy to be accurately detected, and should also meanwhile be small enough so the AC voltage will not be chopped off too much. The suggested value is from 100 us to 1 ms depending on the specific application scenario. In FIG. 3, the modulator encoding block 300 is to provide a control interface for human being. In this exemplary embodiment, the modulator encoding block 300 has two slide bars to control the brightness of a light and the speed of a fan respectively. The modulator encoding block 300 will encode the command signal based on the settings of the slide bars, and send the information to the modulator MCU 308 which will control the TRIAC 314 to modulate the AC voltage to transmit the command signal. The modulator MCU 308 can compare the command signal encoded by the modulator encoding block 300, and transmit it only when it is different to its previous value which means the settings on the modulator encoding block 300 have been changed by human being. In FIG. 3, the physical switch 302 is optional, and it is used to completely turn off the modulator so no power will be consumed when the modulator is not used.

FIG. 4 shows an embodiment of a receiver of the invention which can control the brightness of a light and the speed of a fan independently. In FIG. 4, the load wire and the neutral wire deliver the AC voltage coming from the modulator shown in FIG. 3. In FIG. 4, the embodiment includes a resistor 402 and a capacitor 404 both coupled between the load wire and the neutral wire. The resistor 402 and the capacitor 404 compose an optional bleeder block to provide the latching current and holding current (when needed) for the TRIAC 314 in FIG. 3. In FIG. 4, the embodiment also includes a diode 406, a resistor 408 and a zener diode 410 which connect in series and then coupled between the neutral wire and the load wire. There are also a diode 414, a NMOSFET 416 and a capacitor 418 which connect in series and then coupled between the neutral wire and the load wire. There is also a capacitor 412 connected in parallel with the zener diode 410. The gate of the NMOSFET 416 is connected to the interconnection of the resistor 408 and the zener diode 410. The embodiment also includes a receiver MCU 432 coupled between the node VCC and the load wire. The diode 406, the resistor 408, the zener diode 410, the capacitor 412, the diode 414, the NMOSFET 416 and the capacitor 418 compose a receiver power supply block which provides power for the receiver MCU 432. In the half cycles when the voltage of the load wire is less than the voltage of the neutral wire, the AC voltage will charge the capacitor 418 through the diode 414 and the NMOSFET 416. In the half cycles when the voltage of the load wire is higher than the voltage of the neutral wire, the diode 414 and the NMOSFET 416 are off and the capacitor 418 will provide the power for the receiver MCU 432. In FIG. 4, there are also a capacitor 420 and a zener diode 422 connected in series and then coupled between the neutral wire and the load wire. There is also a resistor 424 coupled between the node VCC and the interconnection of the capacitor 420 and the zener diode 422. The capacitor 420, the zener diode 422 and the resistor 424 compose a negative leading edge detection block, to detect the negative leading edge of the AC voltage. The embodiment also includes a capacitor 428 and a zener diode 430 connected in series and then coupled between the neutral wire and the load wire. There is also a resistor 426 coupled in parallel with the zener diode 430. The resistor 426, the capacitor 428 and the zener diode 430 compose a positive leading edge detection block, to detect the positive leading edge of the AC voltage. Both the negative leading edge detection block and the positive leading edge detection block couple to the receiver MCU 432. In FIG. 4, there are also a TRIAC 434, a resistor 436 and a optoisolator TRIAC driver 438 coupled together to compose a controlling block, to control the operation of a light 448 which is coupled between the neutral wire and the A2 of the TRIAC 434. There are also a TRIAC 440, a resistor 442 and a optoisolator TRIAC driver 444 coupled together to compose another controlling block, to control the operation of a fan 446 which is coupled between the neutral wire and the A2 of the TRIAC 440. The A1 terminals of the TRIAC 434 and the TRIAC 440 are coupled to the load wire. The receiver MCU 432 is also coupled to the optoisolator TRIAC driver 438 and the optoisolator TRIAC driver 444 to control the controlling blocks.

The modulator shown in FIG. 3 and the receiver shown in FIG. 4 compose an exemplary embodiment of an AC power line instruction system. By changing the settings of the slide bars in the modulator encoding block 300, a command signal can be encoded and the modulator MCU 308 will modulate the AC voltage accordingly. The receiver will decode the command signal by measuring the relationship between the timing of the leading edges of the AC voltage. The receiver MCU 432 can control the brightness of the light 448 and the speed of the fan 446 independently based on the command signal decoded. For example, the command signal can have 6 digital bits in total, with 4 bits to control the brightness (16 levels) of the light 448 and another 2 bits to control the speed (4 levels) of the fan 446. The command signal can include one or more “starting bits” (for example “101”) to indicate the start of the transmission, and one or more “ending bits” (for example “000”) to indicate the end of the transmission. Having the starting bits or ending bits or both may make the transmission more reliable. The command signal can also have “an address” which is represented by a number of address bits. When the receiver decodes the command signal, it will compare the address received with the receiver's own pre-assigned address. The receiver can react to the command signal decoded only if these addresses match, otherwise the receiver will ignore the command signal received. Thus many different receivers can share a common AC power line and still be controlled separately. The transmission protocol (including the definitions of the number of bits, the starting bits, the ending bits and the address bits) is very flexible and subject to the user's own definition.

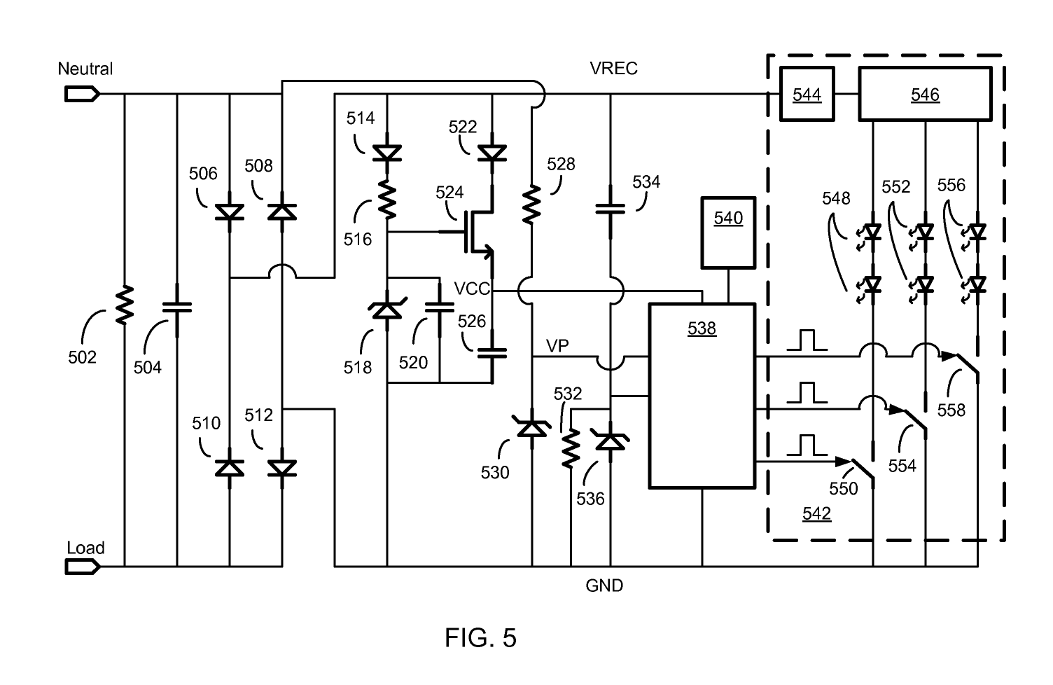

FIG. 5 shows another embodiment of a receiver of the invention which can control the brightness and the color of a light independently. In FIG. 5, the embodiment includes a resistor 502 and a capacitor 504 both coupled between the load wire and the neutral wire. The resistor 502 and the capacitor 504 compose an optional bleeder block to provide the latching current and holding current (when needed) for the TRIAC 314 in FIG. 3. In FIG. 5, the embodiment also includes a diode 506, a diode 508, a diode 510 and a diode 512 coupled to the neutral wire, the load wire, a node VREC and a node GND. The rectified AC voltage between the node VREC and the node GND is a fully rectified version of the AC voltage between the neutral wire and the load wire. In FIG. 5, there are also a diode 514, a resistor 516 and a zener diode 518 connected in series and then coupled between the node VREC and the node GND. There are also a diode 522, a NMOSFET 524 and a capacitor 526 connected in series and then coupled between the node VREC and the node GND. There is a capacitor 520 coupled in parallel with the zener diode 518. The diode 514, the resistor 516, the zener diode 518, the capacitor 520, the diode 522, the NMOSFET 524 and the capacitor 526 compose a receiver power supply block to provide power for a receiver MCU 538 which is coupled to the node VCC and the node GND. There are also a resistor 528 and a zener diode 530 connected in series (at node VP) and then coupled between the neutral wire and the node GND. There are also a capacitor 534 and a zener diode 536 connected in series and then coupled between the node VREC and the node GND. There is also a resistor 532 coupled in parallel with the zener diode 536. The resistor 532, the capacitor 534 and the zener diode 536 compose a positive leading edge detection block. When the voltage of the node VP is low (clamped by the zener diode 518 to about 0.7V below the voltage of the node GND), the positive leading edge detection block can detect the positive leading edge of the AC voltage. The resistor 532, the capacitor 534 and the zener diode 536 together can also be used as a negative leading edge detection block. When the voltage of the node VP is high (clamped by the zener diode 518 to about several volts above the voltage of the node GND), the negative leading edge detection block can detect the negative leading edge of the AC voltage. In FIG. 5, the receiver MCU 538 couples to the positive (or negative) leading edge detection block, the node VP, a receiver memory block 540 and a light 542. The light 542 is also coupled between the node VREC and the node GND. The light 542 includes a PFC (Power Factor Correction) block 544 and converter block 546 coupled to each other. There are a red color LED string 548 and a switch 550 connected in series and then coupled between the converter block 546 and the node GND. There are a green color LED string 552 and a switch 554 connected in series and then coupled between the converter block 546 and the node GND. There are also a blue color LED string 556 and a switch 558 connected in series and then coupled between the converter block 546 and the node GND. The receiver MCU 538 couples to the switch 550, the switch 554 and the switch 558. The PFC block 544 is to make sure the current it draws is proportional to the AC voltage so the power factor (PF) is close to 1. The converter block 546 can convert the voltage to provide the right voltage values for the red color LED string 548, the green color LED string 552 and the blue color LED string 556. The switch 550, the switch 554 and the switch 558 will turn on and off the red color LED string 548, the green color LED string 552 and the blue color LED string 556 respectively. The receiver MCU 538 can control the turn on time of the switch 550, the switch 554 and the switch 558 with different PWM (Pulse Width Modulation) pulses, to control the brightness and the color of the light 542. The receiver MCU 538 will decode the command signal by measuring the relationship between the timing of the leading edges of the AC voltage, and then control the brightness and the color of the light 542 based on the command signal decoded. For example, the command signal can have 16 digital bits in total, with 8 bits to control the brightness (256 levels) of the light 542 and another 8 bits to control the color (256 different colors) of the light 542. The receiver memory block 540 can store the command signal after the AC voltage is turned off, and the receiver MCU 538 can use the command signal stored by the receiver memory block 540 to control the light 542 before a new command signal is received when the AC voltage is turned on next time. In the embodiment shown in FIG. 5, the color and the brightness of the light 542 can be controlled independently by the command signal delivered via the load wire. Also since the AC voltage is not chopped off too much during normal operation so its integrity is almost uncompromised, a good power factor of the AC voltage can be achieved.

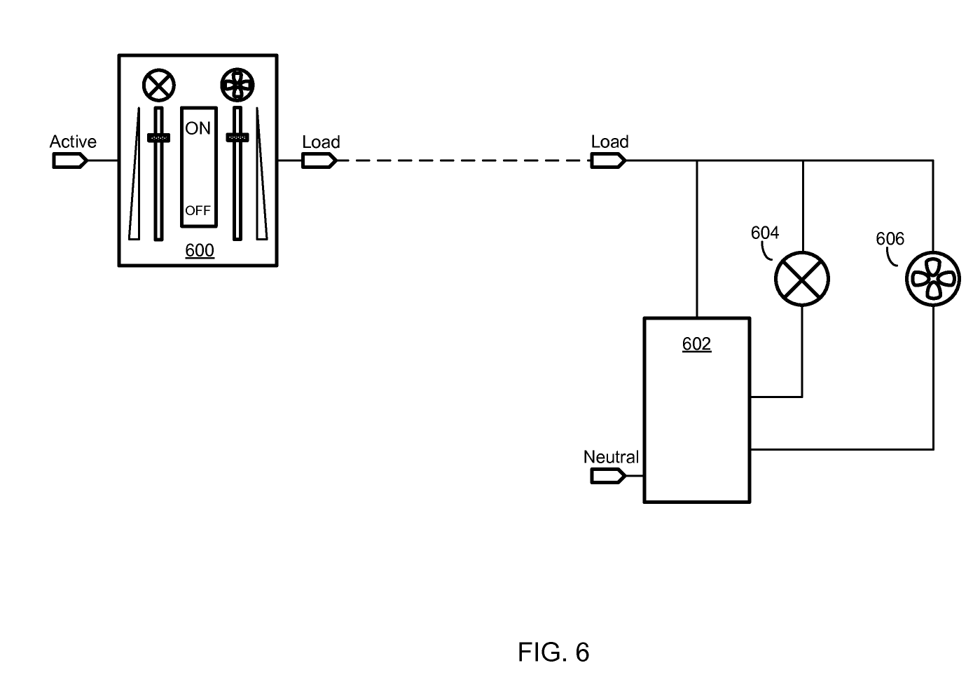

FIG. 6 shows an embodiment of an AC power line instruction system of the invention. The power line instruction system shown here includes a modulator to modulate the AC voltage to transmit a command signal, and a receiver to decode the command signal and to control the electrical devices. In FIG. 6, the embodiment includes a modulator 600 coupled between an active wire and a load wire. The embodiment also includes a receiver 602 coupled between the load wire and a neutral wire. There are also a light 604 and a ceiling fan 606 coupled between the load wire and the receiver 602. The modulator 600 is usually mounted on the wall and it has slide bars to control the brightness of the light and the speed of the fan independently. The modulator 600 is coupled between the active wire and the load wire using the two-wire connection. The load wire is routed from the modulator 600 to the light 604 and ceiling fan 606 which are usually mounted on the ceiling. The receiver 602 can measure the AC voltage and decode the command signal, and then control the brightness of the light 604 and the speed of the ceiling fan 606 according to the command signal.

While the present disclosure describes several embodiments, these embodiments are to be understood as illustrative and do not limit the claim scope. The structures and methods disclosed in this invention can have many variations and modifications. Having thus described the present invention it will be apparent to one of ordinary skill in the art that various modifications can be made within the spirit and scope of the present invention.

For example, the modulator switch element 314 can also be a SCR (Silicon Controlled Rectifier), a MOSFET (Metal Oxide Semiconductor Field Effect Transistor), a BJT (Bipolar Junction Transistor), or an IGBT (Insulated Gate Bipolar Transistor), or any combinations of them.

For example, the positive leading edge detection block and the negative leading edge detection block can be both implemented using a capacitor coupled between the AC voltage and a bias point. The bias point can be set at half of the voltage of node VCC using a resistor divider.

For example, the positive (instead of the negative) leading edges of the AC voltage or both the positive and the negative leading edges of the AC voltage can be modulated to transmit the command signal. For example, more than one digital bit can be transmitted each cycle depending on the amount of the modulation of the AC voltage. For example, if the time delay T1 equals to half of the time delay T0, it means a logic signal “00”. If the time delay T1 is 200 us more than half of the time delay T0, it means a logic signal “01”. If the time delay T1 is 400 us more than half of the time delay T0, it means a logic signal “10”. If the time delay T1 is 600 us more than half of the time delay T0, it means a logic signal “11”. Thus two digital bits can be transmitted each cycle. In similar manner, more than two digital bits can also be transmitted each cycle as long as the positive and negative leading edges of the AC voltage can be accurately modulated and detected.

For example, the electrical device can be a fluorescent light and its brightness can be controlled using the AC power line without any additional control signal wires needed. For example, the electrical device can be a gate and its opening position can be controlled using the AC power line without any additional control signal wires needed. For example, not only the brightness and the color of light can be controlled, but also the light can change its lighting pattern (such as flashing, rotating color, etc.).

Accordingly, the scope of the invention should be determined not by the embodiments illustrated, but by the appended claims and their legal equivalents.

What is claimed is:

1. An AC power line instruction system, comprising:
an AC voltage to power at least one electrical device, and,
a modulator comprising a modulator MCU, a modulator power supply block to power said modulator MCU, a zero crossing detection block and a modulator switching block, whereby the timing of a plurality of leading edges of said AC voltage is modulated to transmit a command signal, and,
at least one receiver comprising a receiver MCU, a receiver power supply block to power said receiver MCU, a positive leading edge detection block and a negative leading edge detection block, whereby a relationship between the timing of said leading edges of said AC voltage is measured to decode said command signal,
whereby said command signal decoded by said receiver can be used to control the operation of said electrical device coupled to said receiver.

2. The AC power line instruction system of claim 1 wherein:
said modulator power supply extracts power from the voltage difference across said modulator switching block when said modulator switching block is off.

3. The AC power line instruction system of claim 1 wherein:
said modulator switching block comprises a modulator switch element to turn on and off said AC voltage, and said modulator switch element can be a TRIAC, a SCR, a MOSFET, a BJT, or an IGBT, or any combinations of them.

4. The AC power line instruction system of claim 3 wherein:
said modulator switch element is a TRIAC, and said receiver further comprises a bleeder block to provide enough latching current or holding current or both for said TRIAC.

5. The AC power line instruction system of claim 1 wherein:
said modulator modulates said AC voltage to transmit said command signal temporarily or permanently.

6. The AC power line instruction system of claim 1 wherein:
said receiver further comprises at least one controlling block to control the operation of said electrical device which can include but limited to light color, lighting pattern, light brightness, fan speed, fan rotation direction, door opening position.

7. The AC power line instruction system of claim 6 wherein:
said modulator modulates said AC voltage to transmit said command signal temporarily, and said electrical device is a LED light with PFC feature,
whereby the integrity of said AC voltage is uncompromised, so good power factor can be achieved even when said LED light operates at different colors and brightness levels and very wide color and brightness adjusting range with very fine adjusting step can be achieved for said LED light.

8. The AC power line instruction system of claim 6 wherein:
said electrical device can be a ceiling fan together with a light, and the speed of said ceiling fan or the brightness of said light can be adjusted independently based on said command signal.

9. The AC power line instruction system of claim 6 wherein:
said electrical device can be a fluorescent light, and the brightness of said light can be adjusted based on said command signal.

10. The AC power line instruction system of claim 1 wherein:
said command signal can include at least one starting bit or at least one ending bit or both.

11. The AC power line instruction system of claim 1 can comprise a plurality of receivers, wherein:
each of said receivers can have an address, and said command signal can include information of said address,
whereby the operation of said electrical device coupled to said receiver with said address can be controlled.

12. The AC power line instruction system of claim 1 wherein:
said receiver further comprises a receiver memory block to store said command signal after said AC voltage is turned off by said modulator,
whereby said command signal stored can be used to control the operation of said electrical device when said AC voltage is turned on next time by said modulator.

13. The AC power line instruction system of claim 1 wherein:
said modulator can further comprise a physical switch connected in series with said modulator switching block, to turn off the AC power line instruction system.

14. The AC power line instruction system of claim 1 wherein:
said modulator can further comprise a modulator encoding block, to encode said command signal based on a setting from a slide bar, a rotary switch or a button or any combinations of them.

15. The AC power line instruction system of claim 14 wherein:
said modulator transmits said command signal only when said command signal changes its value.

16. A method to command at least one electrical device powered by an AC voltage, comprising steps of:
(a) transmitting a command signal by modulating the timing of a plurality of leading edges of said AC voltage using a modulator, and
(b) measuring the timing of said leading edges of said AC voltage by a receiver, and
(c) decoding said command signal by finding the relationship between the timing of said leading edges of said AC voltage, and
(d) commanding the operation of said electrical device coupled to said receiver using said command signal decoded by said receiver.

17. The method to command at least one electrical device as claimed in claim 16, wherein:
in step (a) the timing of said leading edges of said AC voltage can be modulated temporarily or permanently, to transmit said command signal.

18. The method to command at least one electrical device as claimed in claim 16, wherein:
in step (a) said command signal can be transmitted when its value changes.

19. The method to command at least one electrical device as claimed in claim 16, wherein:
step (a) further comprises of inserting an address into said command signal, and step (c) further comprises of matching the address of said receiver with said address inside said command signal,
Whereby said receiver will use said command signal to command the operation of said electrical device when said address is matched.

20. The method to command at least one electrical device as claimed in claim 16, wherein:
step (c) further comprises of storing said command signal after said AC voltage is turned off,
Whereby said command signal stored can be used to command the operation of said electrical device when said AC voltage is turned on next time.
